(19) United States
(12) Patent Application Publication
(10) Pub. No.: US 2020/0076106 A1
(43) Pub. Date: Mar. 5, 2020

(54) FEMALE CONTACT WITH LATERAL RETAINING BLADES FOR MALE CONTACT AND CONNECTION ASSEMBLY INCLUDING SUCH FEMALE AND MALE CONTACTS

(71) Applicant: Aptiv Technologies Limited, St. Michael (BB)

(72) Inventor: Houssem Eddine Miled, Ivry-sur-Seine (FR)

(21) Appl. No.: 16/677,058

(22) Filed: Nov. 7, 2019

Related U.S. Application Data
(63) Continuation of application No. 16/062,381, filed on Jun. 14, 2018, now abandoned.

(30) Foreign Application Priority Data
Dec. 17, 2015 (FR) 1562689

(51) Int. Cl. H01R 13/11; H01R 13/115

(52) U.S. Cl. CPC H01R 13/113; H01R 13/18; H01R 13/115

(57) ABSTRACT

A female electrical contact for a cable connector comprising a cage for housing the tongue of a male contact. The cage includes two side elastic retaining blades for limiting the side movements of the tongue, in particular under the effect of vibration. These elastic retaining blades may bear on a protective sleeve that surrounds the cage so as to also limit the movements of the cage inside the sleeve.

### CROSS-REFERENCE TO RELATED APPLICATIONS

This application is a continuation application which claims priority under 35 U.S.C. § 371 to U.S. application Ser. No. 16/062,381, filed Jun. 14, 2018 which is a national stage application under 35 U.S.C. § 371 of PCT Application Number PCT/EP2016/080791 having an international filing date of Dec. 13, 2016, which designated the United States, said PCT application claiming the benefit of French Patent Application No. 1562689, filed Dec. 17, 2015, the entire disclosure of each of which are hereby incorporated herein by reference.

### TECHNICAL FIELD OF THE INVENTION

The invention relates to the field of electrical connectors and, in particular, electrical connectors for motor vehicles.

### BACKGROUND OF THE INVENTION

Connectors, in particular those mounted on internal combustion engines, may be subjected to strong vibration (for example 60 G to 1000 Hz). It is therefore important that the male and female contacts of these connectors can maintain, in the long term, electrical contact that is the least resistive possible, that they are not the cause of arcing or excessive heating, and that they are not the seat of fretting corrosion.

Female electrical contacts, such as those described in U.S. Pat. No. 5,681,190, comprising a cage and a sleeve, have been proposed. Such female electrical contacts are intended to be housed in cavities formed in a housing made of a dielectric material. The cage is made from stamped and bent sheet metal. It extends in a longitudinal direction between:
a mating end provided with an opening through which a tongue of a male contact can be inserted into the cage, and
a securing end from which the contact extends in the form of a securing portion to which a cable may be secured and electrically connected, for example by welding or crimping.

The cage has essentially a parallelepiped shape open at each of the mating and securing ends, forming a tube with four walls. It therefore comprises a bottom wall, a top wall and two side walls extending between the bottom wall and the top wall. These bottom wall, top wall and side walls define an internal space for receiving and housing the tongue of a male contact inserted via the opening at the mating end. The top wall and bottom wall each comprises at least one contact blade, which is elastic and extends, from the cage towards a free end, transversely to the longitudinal direction.

Furthermore, the sleeve surrounds the bottom, top and side walls, at least partially, on the outside of the cage.

### SUMMARY OF THE INVENTION

It may be advantageous to be able to use this type of female contact with male contacts of various shapes and sizes, without having to design and manufacture a female contact adapted to fit each shape or size of the male contact. For example, in the case of a male contact with a tongue of flattened shape, the contact blades exert a pressure on the main faces of the tongue (essentially parallel to the top and bottom walls of the cage), to establish electrical contact between them. However, vibration can cause the tongue to move and oscillate between the contact blades, in a plane parallel to the bottom and top walls. Such movements can be detrimental to the quality of the electrical contact between the male and female contacts thus connected.

One aim of the invention is to at least partially overcome this problem and to ensure longer lasting good quality contact between the male and female contacts.

A female electrical contact, with or without a sleeve, in which at least one of the side walls has a retaining blade is presented. This retaining blade is elastic and is cut into a side wall. It remains attached to the side wall in which it is cut at a junction. The junction is closer to the mating end than to the securing end. The retaining blade extends from the junction towards a free end located closer to the securing end than to the mating end. The free end protrudes into the internal space.

By virtue of these provisions, each side retaining blade interacts elastically with an edge of the tongue of the male contact to limit movement of the latter in the female contact in which it is housed. For example, each retaining blade may interact with an edge (essentially perpendicular to the main faces) of the tongue of the male contact so as to limit, in the cage its movement parallel to the bottom and top walls.

The female electrical contact according to the invention may further comprise one or other of the following features, taken alone or in combination with one or more others:
a sleeve which at least partially surrounds the bottom wall, top wall and side walls on the outside of the cage;
the retaining blades comprise a pressure zone bearing, when a tongue of a male contact is housed in the cage, on the sleeve if the contact is made up of two parts, or bearing on the inside faces of a housing cavity in which the cage is inserted, if the female contact is formed in one piece;
the sleeve and/or the cage comprises two ramps, each bent towards the inside and/or outside of the cage; for example, these two ramps are bent towards the side walls and the internal space of the cage, at the mating end thereof;
the contact blades corresponding to the top wall and bottom wall comprise, at their free end, an edge between two surfaces forming an acute angle with a plane parallel to the bottom wall and top wall;
the contact blades corresponding to the top wall and bottom wall are connected to the cage at the side walls;
the cage is integrally formed in one piece;
the top wall of the cage comprises a junction line between two edges of a bent blank; and
the junction line is at least partially covered by a continuous portion of the sleeve extending above and parallel to the top wall of the cage and bent, on either side thereof, parallel to the side walls.

According to another aspect, the invention relates to a connection assembly. Such a connection assembly may, for example, comprise an electrical connector and counter-connector respectively comprising a female electrical contact with two retaining blades and a male electrical contact having a tongue with a dimension, perpendicular to the longitudinal direction and parallel to the bottom wall and top wall, this is less than the corresponding internal dimension of the cage, and greater than the spacing between the free ends of the retaining blades (when they are not stressed, before insertion of the tongue into the cage).

This connection assembly optionally includes a tongue having a cross-sectional shape of a flattened parallelepiped and the retaining blades each bear respectively on an edge of the tongue corresponding to the short side of this parallelepiped.

### BRIEF DESCRIPTION OF THE SEVERAL VIEWS OF THE DRAWING

Characteristics and advantages of the invention shall appear upon reading the detailed description and the appended drawings, in which:

FIG. 1 is a perspective view of a connection assembly comprising a male contact and a female contact;

FIG. 2 is a perspective view of the cage of the female contact of FIG. 1;

FIG. 3 is a perspective view of the front of the cage of FIG. 2;

FIG. 4 is a perspective cross section view of the cage of FIGS. 2 and 3;

FIG. 5 is a perspective cross section view of the cage of FIGS. 2 and 3 with a sleeve around the cage and a male contact tongue inserted in the cage;

FIGS. 6A and 6B illustrate a male contact tongue having a shape different from that inserted in the cage of the female contact shown in FIG. 5;

FIGS. 7A and 7B are longitudinal cross section views of a variant of the cage of the female contact shown in FIGS. 1 to 5, with a male contact tongue inserted in the cage; and

FIGS. 8A and 8B are longitudinal cross section views of another variant of the cage of the female contact shown in FIGS. 1 to 5, with a male contact tongue inserted in the cage.

In this document, the terms “front”, “rear”, “above”, “below”, etc. are purely conventional and, where appropriate, refer to the orientations as shown in the figures.

### DETAILED DESCRIPTION OF THE INVENTION

The connection assembly 100 shown in FIG. 1 includes a female contact 1 and a male contact 2 (of which only the tongue 3 is shown in the figures). The female contact 1, alone or with other contacts, may be housed in a connector housing (not shown) made of electrically insulating material. Similarly, the male contact 2, alone or with other contacts, may be housed in a housing of a counter-connector (not shown) made of electrically insulating material designed to be coupled to the connector containing the female contact 1.

The female contact 1 and the male 2 contact are coupled, or mated, electrically and mechanically by inserting the tongue 3 into the cage 4 of the female contact 1, in a direction of insertion essentially parallel to the longitudinal direction L of the male contact 2 and the female contact 1.

The female contact 1 also comprises a securing portion 5 extending the cage 4, towards the rear thereof, in the longitudinal direction L. The securing portion 5 is in this case designed to receive and crimp therein the end of a cable (not shown). The female contact 1 also comprises a protective sleeve 6.

The cage 4 is obtained by stamping and bending sheet metal made of conductive material, e.g. copper, aluminum, or an alloy of these metals. The sleeve 6 is also obtained by stamping and bending sheet metal made of conductive material, e.g. steel.

As shown in FIG. 2, the cage 4 has essentially a parallelepiped shape. It extends longitudinally parallel to the direction L, between a mating end 7, towards the front, and a securing end 8, towards the rear. The cage 4 forms (without taking into account the cut-outs in the walls) a tube of essentially rectangular cross section. This tube therefore has essentially four walls: a bottom wall 9, a top wall 10 and two side walls 11. It is open at each of its mating end 7 and securing end 8. On the side of the mating end 7, there is an opening through which the tongue 3 of a male contact 2 may be inserted. The bottom wall 9, top wall 10 and side walls 11 thus define an internal space for receiving and housing the tongue 3.

For the embodiment described in this case, the cage 4 is formed in one piece, by bending, parallel to the longitudinal direction L, a stamped shape and bringing the edges of the stamped blank together, substantially at a median junction line 12 of the top wall 10 of the cage 4. The junction line 12 is partially covered by a continuous portion 24 of the sleeve 6 (see FIG. 1) extending above and parallel to the top wall 10 of the cage 4. This continuous portion 24 is bent, on either side of thereof, parallel to the side walls 11. It helps to prevent the edges of the cage 4 from moving apart.

The top wall 10 and bottom wall 9 each comprise two contact blades 13 which are elastic and extend, from the cage 4 towards a free end 14, transversely to the longitudinal direction L. In the embodiment described in this case, the contact blades 13 corresponding to the top wall 10 and bottom wall 9 are connected to the cage at the side walls 11. It can be seen that relatively wide cut-outs are made around these contact blades 13. Thus, a degree of elasticity is imparted to the cage 4 which makes it possible to damp some of the energy of the vibration and limits any relative movement between the tongue 3 and the contact blades 13. Thus, this elasticity ensures good resistance to vibration, and at the same time good electrical performance.

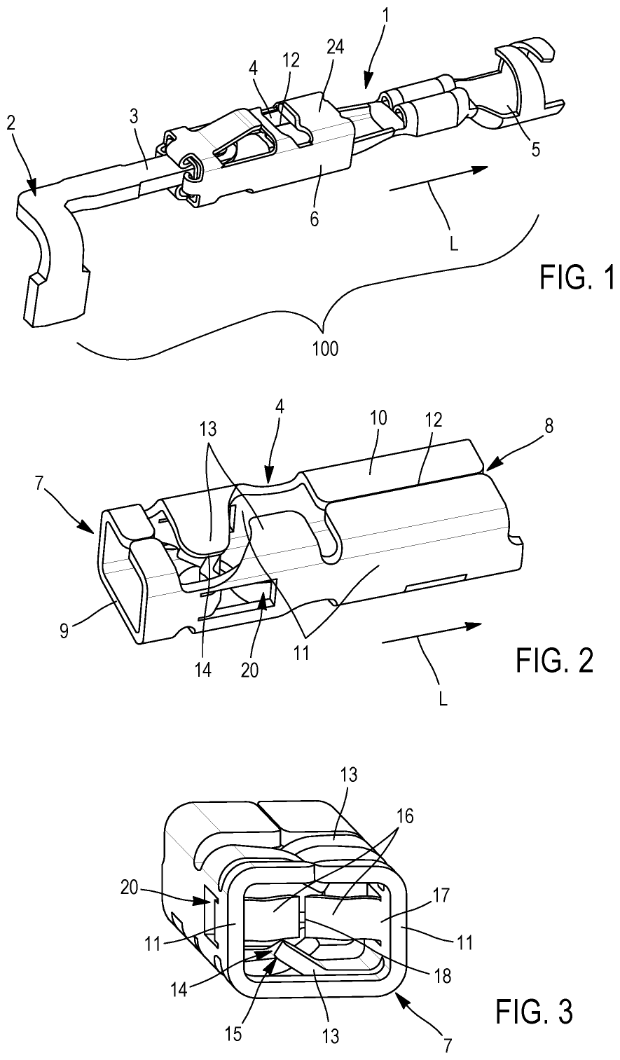

As shown in FIG. 3, the contact blades 13 comprise, at their free end 14, an edge 15 between two surfaces forming an acute angle with a plane parallel to the bottom wall 9 and top wall 10. Each edge 15 is essentially tangential to a straight line parallel to the longitudinal direction L. Each edge 15 thus allows the contact blades 13 to bite into the material constituting the tongue 3, when it is inserted in the cage 4, which thus helps to establish the least resistive electrical contact possible between the contact blades 13 and the tongue 3. In addition, each edge 15 makes it possible to better anchor the tongue 3 between the contact blades 13 and to exert on the tongue 3 a friction force tending to limit as much as possible the relative movement of the tongue 3 with respect to the cage 4 in a plane parallel to the top wall 10 and bottom wall 9.

The side walls 11 each comprise a retaining blade 16, which is elastic and cut into a side wall 11 to which it remains attached at a junction 17. Each retaining blade 16 therefore extends from a junction 17 to a free end 18. Each retaining blade 16 is bent towards the rear of the cage 4, that is to say towards the securing portion 5, in order to facilitate the insertion of the tongue 3 into the cage 4 from the opening corresponding to the mating end 7. As can be seen in FIGS. 3 and 4, when no tongue 3 is inserted in the cage 4, the retaining blades 16 extend generally transversely in the internal space of the cage 4, to the extent that they could almost meet at the center thereof. The length and shape of the retaining blades 16 allow the latter to adapt to many shapes of tongues 3, whether the edges 19 thereof are parallel, as in FIG. 6A, or beveled, as in FIG. 6B.

Each side wall 11 has a window 20 corresponding to the portion of the cage 4 that is cut out to form a respective retaining blade 16.

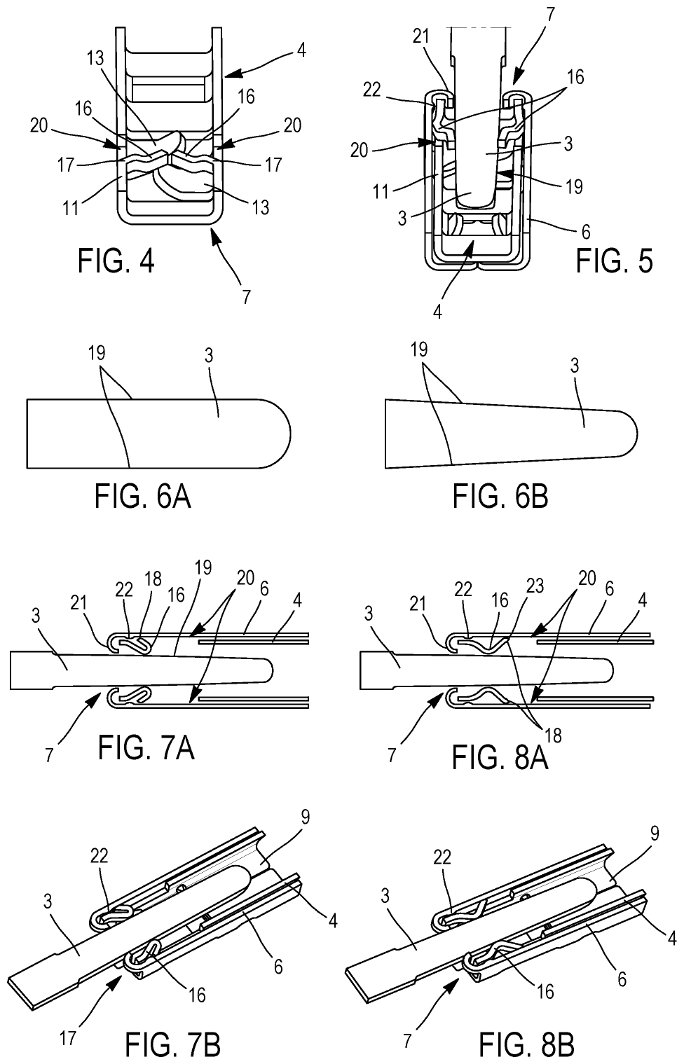

Each retaining blade 16 has, in longitudinal section, parallel to the bottom wall 9 and top wall 10, an “S” shape. As shown in FIG. 5, a portion of this “S” shape is intended to come into contact with a longitudinal edge 19 of the tongue 3 when the latter is inserted in the cage 4. Another portion of this “S” shape is intended to come into contact with the inside face of the sleeve 6. This latter portion of the “S” shape forms a pressure zone bearing on the sleeve 6 when a tongue 3 of a male contact 2 is housed in the cage 4. Thus, the retaining blades 16 not only guide and retain the tongue 3 in the cage 4, but also limit, on the one hand, transverse movements (in a plane parallel to the top wall 10 and bottom wall 9) of the tongue 3 with respect to the cage 4 and, on the other hand, movements of the cage 4 with respect to the sleeve 6. Furthermore, the pressure of the retaining blades 16 on the inside face of the sleeve 6 increases the force exerted by the retaining blades 16 on the tongue 3, thus contributing to a better retention of the tongue 3 in the cage 4.

As can be seen, particularly in FIG. 5, the sleeve 6 comprises two ramps 21. Each ramp 21 is bent in towards the internal space of the cage 4 at the mating end 7 thereof. They guide the tongue 3 when it is inserted into the cage 4. These ramps 21 make it possible to attach the sleeve 6 in the cage 4 and to block the movement of the cage 4 in the sleeve 6, in the longitudinal direction L. Furthermore, these ramps 21 may each form a bearing point which also helps to limit the transverse movement (in a plane parallel to the top wall 10 and bottom wall 9) of the tongue 3 with respect to the cage 4.

The sleeve 6 also has, on its inside face, ribs 22 interfering with the external surface of the side walls 11 of the cage 4, and also helping to limit the transverse movement (in a plane parallel to the top wall 10 and bottom wall 9) of the tongue 3 with respect to the cage 4.

By virtue of the retaining blades 16, it is possible to reduce the transverse relative movements of the tongue 3 in the cage 4 to 0.8 μm or less. For this specific example, the average width of the tongue 3 is about 1.2 mm, and the width of the cage is 1.8 mm.

Variants of the above embodiment are described below with reference to FIGS. 7A, 7B, 8A and 8B.

The variant of FIGS. 7A and 7B differs from the above embodiment essentially in that each retaining blade 16 is bent, substantially half way along its length, by bringing its free end 18 through the window so that the end is in contact with the inside surface of the sleeve 6 and bears thereon. The portion which is bent (substantially in the middle) of each retaining blade 16 comes into contact with a longitudinal edge 19 of the tongue 3 when the latter is inserted into the cage 4. This shape may possibly help confer greater rigidity to the retaining blades 16, compared to the above embodiment.

The variant of FIGS. 8A and 8B differs from the above embodiments essentially in that each retaining blade 16 bears on the inside surface of the sleeve 6 via its free end 18 instead of a bent portion. The free end 18 rests on the inside surface of the sleeve 6 via an edge 23 biting into the material constituting the sleeve 6 and thus increasing the friction between the retaining blade 16 and the inside surface of the sleeve 6 when the tongue 3 tends to move transversely in a plane parallel to the top wall 10 and bottom wall 9.

In general, the female contact 1 according to the invention may, thanks to the elasticity of the side blade(s), accommodate various shapes and sizes of tongues 3 while maintaining, and even improving, performance when the female contact 1 and male contact 2 are subjected to vibration.

Optionally, if the female contact 1 is not surrounded by a sleeve 6 and the female contact 1 is formed in one piece, what has just been described above in relation to the sleeve 6 may be transposed to the inside surfaces of a housing in which the female contact 1 is housed.

We claim:

1. A female electrical contact, comprising:
a cage extending in a longitudinal direction between a mating end provided with an opening configured to receive a tongue of a male contact and a securing end configured to secure and electrically connect a cable,
wherein the cage comprises a bottom wall, a top wall, and two side walls extending between the bottom wall and the top wall,
wherein the bottom wall, the top wall and the side walls define an internal space for receiving and housing the tongue of the male contact inserted within the opening,
wherein the top wall and the bottom wall each comprise an elastic contact blade which extends from the cage towards a free end in a direction transverse to the longitudinal direction.

2. The female electrical contact as claimed in according to claim 1, wherein at least one of the side walls has an elastic retaining blade which is cut into a side wall to which it remains attached at a junction, said retaining blade closer to the mating end than to the securing end, and said retaining blade extending from the junction towards a free end that is located closer to the securing end than to the mating end, said free end protruding into the internal space.

3. The female electrical contact as claimed in according to claim 2, further comprising a sleeve which at least partially surrounds the bottom wall, the top wall, and the side walls on the outside of the cage.

4. The female electrical contact as claimed in according to claim 3, wherein the sleeve comprises two ramps, each bent towards the side walls and the internal space of the cage, at the mating end thereof.

5. The female electrical contact according to claim 4, wherein each retaining blade comprises a pressure zone bearing on the sleeve when the tongue of the male contact is housed in the cage.

6. The female electrical contact according to claim 3, wherein the top wall of the cage comprises a junction line between two edges of a bent blank.

7. The female electrical contact according to claim 6, wherein the junction line is at least partially covered by a continuous portion of the sleeve extending above and parallel to the top wall of the cage and bent, on either side thereof, parallel to the side walls.

8. The female electrical contact according to claim 2, wherein the contact blades corresponding to the top wall and the bottom wall comprise an edge between two surfaces forming an acute angle with a plane parallel to the bottom wall and the top wall at their free end.

9. The female electrical contact according to claim 2, wherein the contact blades corresponding to the top wall and the bottom wall are connected to the cage at the side walls.

10. The female electrical contact according to claim 2, wherein the cage is integrally formed in one piece.

11. A connection assembly, comprising:
the female electrical contact according to claim 1 having two retaining blades; and
a male electrical contact having a tongue with a dimension perpendicular to the longitudinal direction and parallel to the bottom wall and the top wall that is less than a corresponding internal dimension of the cage and is greater than a spacing between the free ends of the retaining blades.

12. The connection assembly according to claim 11, wherein the tongue has a cross-sectional shape of a flattened parallelepiped and the retaining blades each bear respectively on a short side of said parallelepiped.
